(19) United States
(12) Patent Application Publication
(10) Pub. No.: US 2017/0265963 A1
(43) Pub. Date: Sep. 21, 2017

(54) DENTAL IMPLANT SURGICAL GUIDE

(71) Applicant: NATIONAL CHUNG CHENG UNIVERSITY, MIN-HSIUNG (TW)

(72) Inventors: Hong-Tzong YAU, MIN-HSIUNG (TW); Yen-Kun LIN, NEW TAIPEI CITY (TW)

(21) Appl. No.: 15/176,828

(22) Filed: Jun. 8, 2016

(30) Foreign Application Priority Data
Mar. 18, 2016 (TW) 105108469

(51) Int. Cl. A61C 1/08; A61C 8/00

(52) U.S. Cl. CPC A61C 1/084; A61C 8/0092; A61C 1/085

(57) ABSTRACT

A dental implant surgical guide includes an upper guide member including a tooth mold and a plurality of first mating connector components, an intermediate guide member including a guide portion, a plurality of first connection portions and a plurality of second mating connector components, and a lower guide member including a body having a downward-facing recess, a plurality of second connection portions located on the top side of the body, a support bar having two opposite ends thereof respectively connected to the body at two predetermined locations and a mounting portion formed on the body.

### BACKGROUND OF THE INVENTION

1. Field of the Invention The present invention relates to dental implant technology and more particularly, to a dental implant surgical guide.

2. Description of the Related Art

Taiwan Patent I 284030 teaches the preparation of a dental implant surgical guide that improves drilling and implant installation accuracy and safety of dental implant surgery.

However, conventional dental implant surgical guides are not practical for direct use in a patient with too many missing teeth or full-mouth toothless. For use in a patient with too many missing teeth or full-mouth toothless, a conventional dental implant surgical guide can simply be attached to the gingiva. However, when installing a conventional dental implant surgical guide, it is necessary to mount a bite on the patient's gingiva, and then to mount the dental implant surgical guide on the bite. The bite is a clay-like plastic material attached to the gingiva and shaped. When the bite is cured, the dental implant surgical guide can then be fastened to the bite. Because gingiva is a part of the soft tissue, using a bite to install a dental implant surgical guide in a patient's gingival has poor positioning effects, and the dental implant surgical guide can slide. Such positioning inaccuracy may lead to incorrect location of implant, and therefore, conventional dental implant surgical guides are not suitable for patients with too many missing teeth or full-mouth toothless.

Further, conventional dental implant surgical guides do not provide spaces for gingiva flap surgery. If a conventional dental implant surgical guide is installed in the mouth of a patient, the dentist will no longer be able to perform a gingiva flap surgery.

### SUMMARY OF THE INVENTION

The present invention has been accomplished under the circumstances in view. It is the main object of the present invention to provide a dental implant surgical guide, which is suitable for patients with too many missing teeth or full-mouth toothless.

To achieve this and other objects of the present invention, a dental implant surgical guide comprises: an upper guide member comprising a tooth mold for tight engagement with the natural teeth or temporary dentures of the opposite jaw when the patient bites, and a plurality of first mating connector components; an intermediate guide member comprising at least one guide portion for providing guidance in the dental implant surgery procedure, a plurality of first connection portions respectively connected to the first mating connector components to secure the upper guide member and the intermediate guide member together, and a plurality of second mating connector components; and a lower guide member comprising a body defining therein a downward-facing recess for mating with the gingiva of the patient, a plurality of second connection portions located on a top side of the body and adapted for the connection of the first mating connector components to secure the lower guide member and the intermediate guide member together, a support bar having two opposite ends thereof respectively connected to the body at two predetermined locations, and at least one mounting portion formed on the body and adapted for the mounting of equal number of mounting members to secure the lower guide member to the gingiva of the patient.

Thus, by means of mating the downward-facing recess with the patient's gingiva, the dental implant surgical guide can be initially secured to the patient's gingiva, and then mounting members can be mounted in the mounting portions to secure the lower guide member to the patient's gingiva of the patient. Therefore, the dental implant surgical guide of the invention is suitable for patients with too many missing teeth or full-mouth toothless.

It is another object of the present invention to provide a dental implant surgical guide, which provides sufficient space for gingiva flap surgery.

Preferably, the body of the lower guide member defines at least one flap space that provides the necessary space for gingiva flap surgery.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational assembly view of a dental implant surgical guide in accordance with the present invention.

FIG. 2 is an exploded view of the dental implant surgical guide in accordance with the present invention.

FIG. 3 corresponds to FIG. 2 when viewed from another angle.

FIG. 4 is a schematic drawing illustrating a status of use of the dental implant surgical guide in accordance with the present invention.

### DETAILED DESCRIPTION OF THE INVENTION

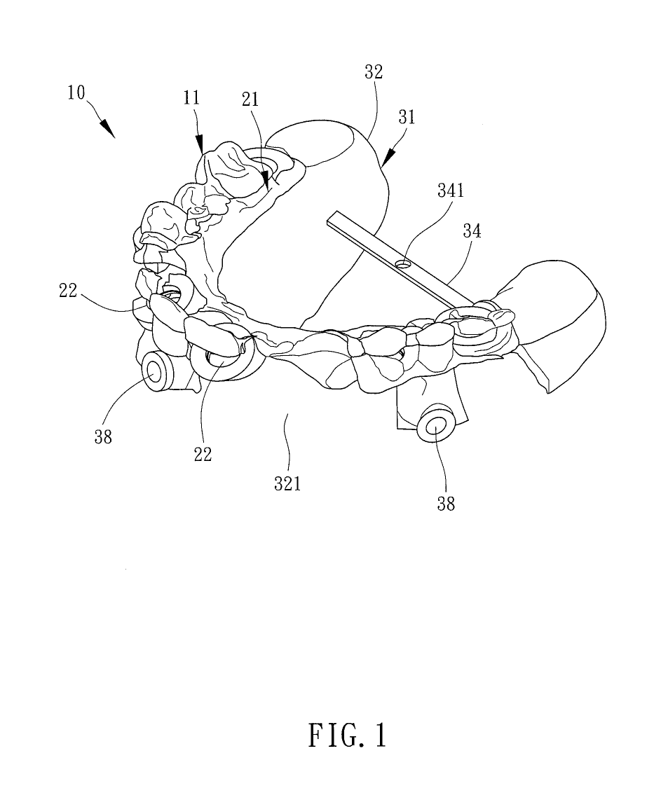

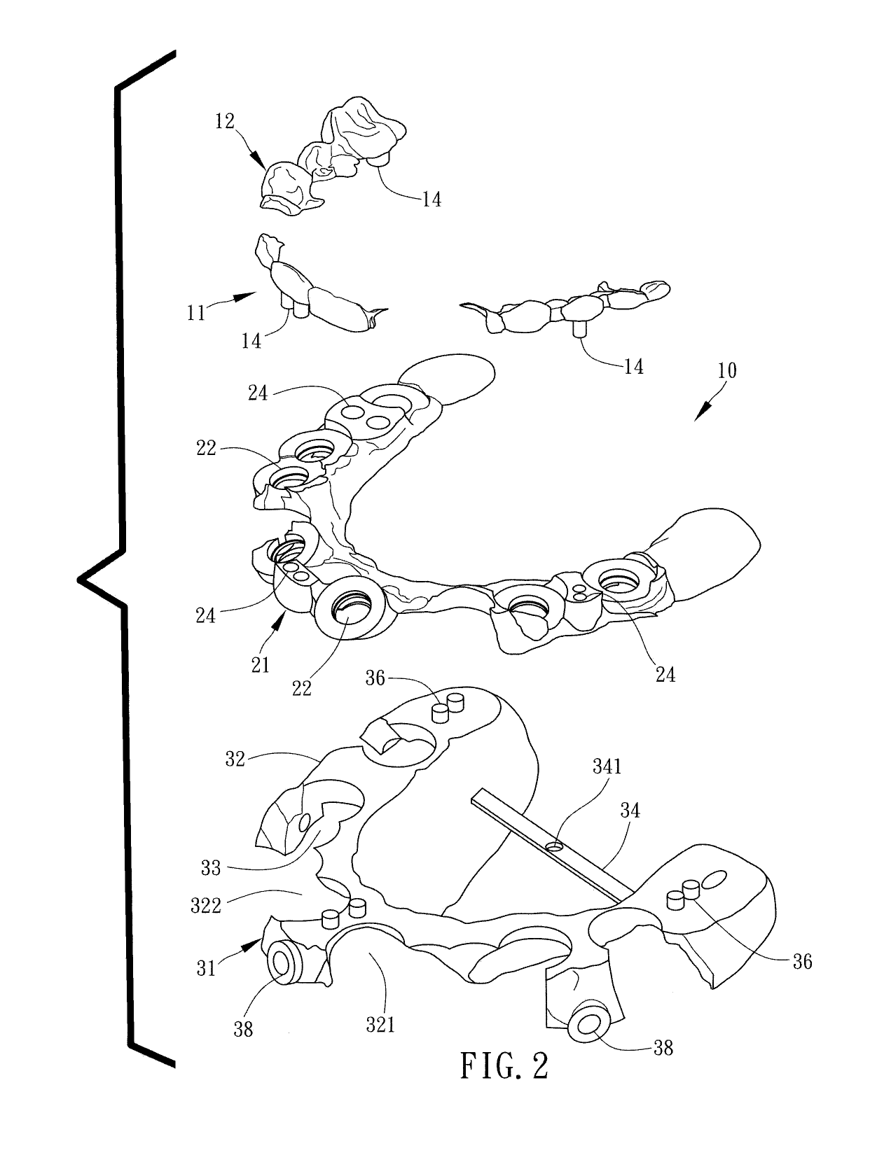

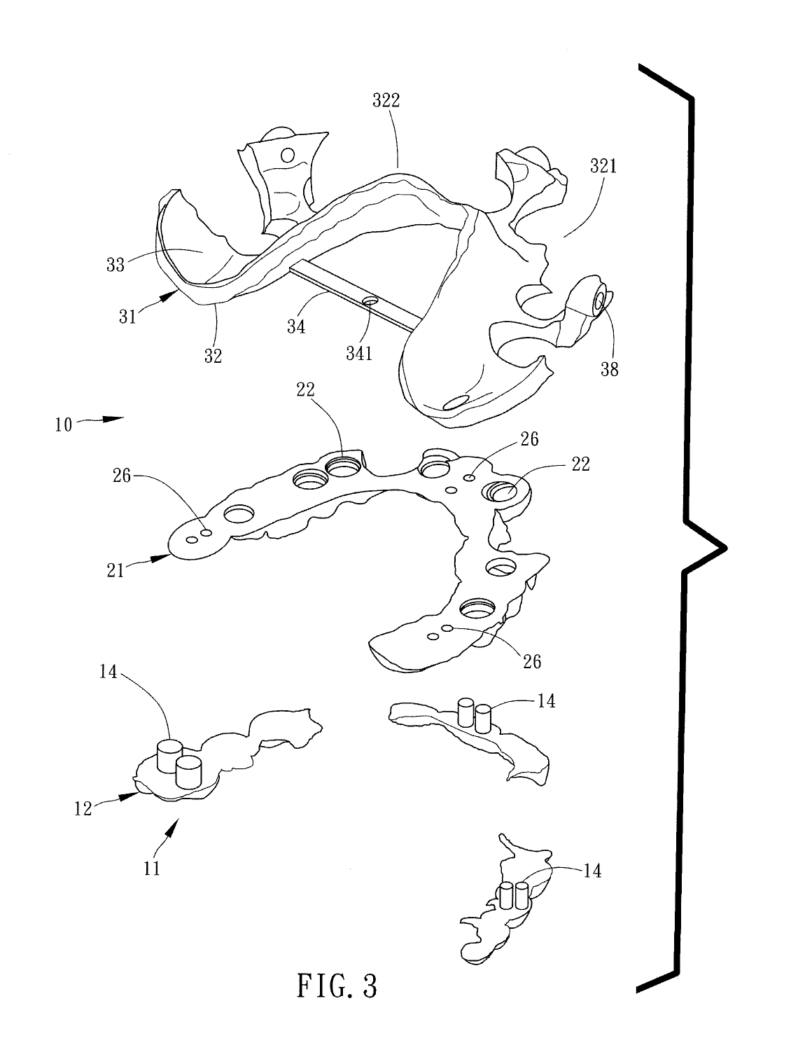

Referring to FIGS. 1-3, a dental implant surgical guide 10 in accordance with the present invention is shown. The double nut ball screw 10 comprises an upper guide member 11, an intermediate guide member 21, and a lower guide member 31.

The upper guide member 11 comprises a tooth mold 12 and a plurality of first mating connector components 14. The tooth mold 12 is adapted for tight engagement with the natural teeth or temporary dentures of the opposite jaw when the patient bites. In this embodiment, the tooth mold 12 consists of three component parts.

The intermediate guide member 21 comprises at least one guide portion 22, a plurality of first connection portions 24 and a plurality of second mating connector components 26. The first connection portions 24 are respectively connected to the first mating connector components 14 to secure the upper guide member 11 and the intermediate guide member 21 together. In this embodiment, the intermediate guide member 21 comprises a plurality of guide portions 22 for providing guidance in the dental implant surgery procedure.

The lower guide member 31 comprises a body 32 defining therein a downward-facing recess 33, a plurality of second connection portions 36 located on a top side of the body 32, a support bar 34 with two opposite ends thereof respectively connected to the body 32 at two predetermined locations for providing support to enhance the overall structural rigidity of the lower guide member 31, and at least one mounting portion 38 formed on the body 32. The downward-facing recess 33 is adapted for mating with the gingiva of the patient. The second connection portions 36 are adapted for the connection of the first mating connector components 26 to secure the lower guide member 31 and the intermediate guide member 21 together. In this embodiment, the lower guide member 31 comprises a plurality of mounting portions 38 adapted for the mounting of equal number of mounting members 381 to secure the lower guide member 31 to the gingiva of the patient by means of friction resistance between the mounting members 381 and the jawbone of the patient. In this embodiment, the mounting members 381 can be plug pins or screw bolts.

In this embodiment, the first mating connector components 14 and the first connection portions 24 establish a connection relationship therebetween by plugging respectively plug pins into respective through holes. The first mating connector components 14 or first connection portions 24 can be plug pins, and the first connection portions 24 or first mating connector components 14 can be through holes for receiving the respective plug pins. Further, the first mating connector components 26 and the second connection portions 36 can also establish a connection relationship therebetween by plugging respectively plug pins into respective through holes.

After understanding of the architecture of the dental implant surgical guide 10, the application of the dental implant surgical guide 10 is explained hereinafter.

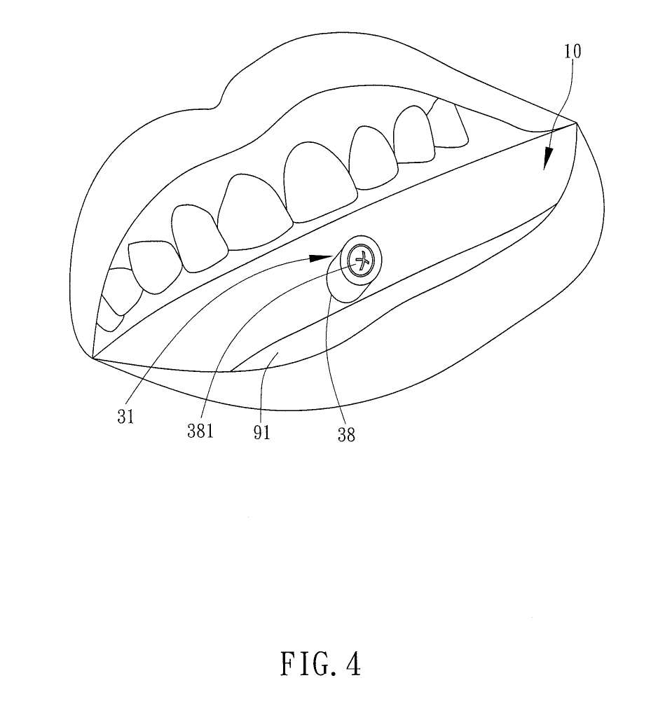

As illustrated in FIGS. 1-4, assemble the upper guide member 11 and the intermediate guide member 21 by means of fastening the first mating connector components 14 and the first connection portions 24 together, and then assemble the lower guide member 31 and the intermediate guide member 21 by means of fastening the first mating connector components 26 and the second connection portions 36 together, and thus, the desired dental implant surgical guide 10 is assembled. Thereafter, use the downward-facing recesses 33 to secure the dental implant surgical guide 10 to the patient's gingiva 91. By means of mating the downward-facing recess 33 with the patient's gingiva 91, an initial positioning effect is achieved. Thereafter, let the patient practice biting, enabling the tooth mold 12 of the upper guide member 11 to be forced into tight engagement with the natural teeth or temporary dentures of the patient's opposite jaw. During the biting action, the lower guide member 31 is slightly moved relative to the gingiva 91 to achieve fine position adjustment. At final, mount respective mounting members 381 in the respective mounting portions 38 to secure the lower guide member 31 to the patient's gingiva 91 by means of friction resistance between the mounting members 381 and the patient' jawbone.

At this time, the installation of the dental implant surgical guide 10 is done, and the follow-up drilling or implant installation procedure can then be performed. During the drilling or implant installation procedure, the guide portions 22 provide guidance.

When wishing to remove the dental implant surgical guide 10 from the patient's gingiva 91, dismount the mounting members 381 for allowing removal of the dental implant surgical guide 10 directly and freely.

It's worth mentioning that, in actual application, the upper guide member 11 can be a one-piece member, or consists of multiple component parts. In this embodiment, the upper guide member 11 consists of three component parts. Similarly, the intermediate guide member 21 can be a one-piece member, or consists of multiple component parts. In this embodiment, the intermediate guide member 21 is a one-piece member. The lower guide member 31 can be a one-piece member, or consists of multiple component parts. In this embodiment, the lower guide member 31 is a one-piece member. As long as each component part has corresponding connection portions or mating connector components, it can be assembled with the other component parts to achieve positioning of the multiple component parts and to provide the expected function of the respective layer.

Further, additional components can be added to the dental implant surgical guide 10 to provide added functions. For example, the body 32 of the lower guide member 31 further defines at least one flap space 321 that provides the necessary space for gingiva flap surgery. However, the at least one flap space 321 is not requisite. Without the at least one flap space 321, the dental implant surgical guide 10 can still achieve the expected mounting and positioning effects.

The body 32 of the lower guide member 31 further defines at least one fenestration portion 322 that provides the necessary space for sinus fenestration. However, the at least one fenestration portion 322 is not requisite. Without the at least one fenestration portion 322, the dental implant surgical guide 10 can still achieve the expected mounting and positioning effects.

The aforesaid at least one flap space 321 and at least one fenestration portion 322 are adapted to provide surgical spaces that may needed during dental implant surgery, facilitating implementation of the complete dental implant procedure.

Further, the support bar 34 can be configured to provide an inspection hole 341 for allowing the dentist to visually check whether the lower guide member 31 has been closely attached to the oral internal organization of the patient or not. For example, if the dental implant surgical guide 10 is to be attached to the upper gingiva, the dentist can see through the inspection hole 341 to check whether the lower guide member 31 has been closely attached to the upper jaw of the patient or not. In this case, the support bar 34 must be arch-shaped; if the dental implant surgical guide 10 is to be attached to the lower gingiva, the dentist can see through the inspection hole 341 to check whether the lower guide member 31 has been closely attached to the tongue of the patient or not. In this case, the support bar 34 can be a straight bar.

1. A dental implant surgical guide, comprising:
an upper guide member comprising a tooth mold and a plurality of first mating connector components, said tooth mold being adapted for engagement with natural teeth or temporary dentures of the opposite jaw when a patient bites;
an intermediate guide member comprising at least one guide portion for providing guidance in the dental implant surgery procedure, a plurality of first connection portions respectively connected to said first mating connector components to secure said upper guide member and said intermediate guide member together, and a plurality of second mating connector components; and
a lower guide member comprising a body defining therein a downward-facing recess for mating with the gingiva of the patient, a plurality of second connection portions located on a top side of the body and adapted for the connection of said first mating connector components to secure said lower guide member and said intermediate guide member together, a support bar having two opposite ends thereof respectively connected to said body at two predetermined locations, and at least one mounting portion formed on said body and adapted for the mounting of equal number of mounting members to secure said lower guide member to the gingiva of the patient,
wherein the body of the lower guide member is a U-shaped member having two arms, and
wherein the support bar is a straight bar and the two opposite ends of the support bar are connected to the two aims of the body of the lower guide member, respectively.

2. The dental implant surgical guide as claimed in claim 1, wherein said body of said lower guide member further defines at least one flap space that provides the necessary space for gingiva flap surgery.

3. The dental implant surgical guide as claimed in claim 1, wherein said body of said lower guide member further defines at least one fenestration portion that provides the necessary space for sinus fenestration.

4. The dental implant surgical guide as claimed in claim 1, wherein said upper guide member consists of a plurality of component parts.

5. The dental implant surgical guide as claimed in claim 1, wherein said intermediate guide member consists of a plurality of component parts.

6. The dental implant surgical guide as claimed in claim 1, wherein said lower guide member consists of a plurality of component parts.

7. The dental implant surgical guide as claimed in claim 1, wherein said first mating connector components and said first connection portions establish a connection relationship therebetween by plugging respectively plug pins into respective through holes.

8. The dental implant surgical guide as claimed in claim 1, wherein said first mating connector components and said second connection portion establish a connection relationship therebetween by plugging respectively plug pins into respective through holes.

9. The dental implant surgical guide as claimed in claim 1, wherein said support bar defines therein an inspection hole.
